(19) United States
(12) Patent Application Publication
(10) Pub. No.: US 2026/0357511 A1
(43) Pub. Date: Nov. 12, 2026

(54) RECYCLABLE PRINTABLE FABRIC

(71) Applicant: GALE PACIFIC LIMITED, Braeside, Victoria (AU)

(72) Inventor: Andrew Nasarczyk, Braeside, Victoria (AU)

(21) Appl. No.: 19/488,247

(22) PCT Filed: May 29, 2024
(86) PCT No.: PCT/AU2024/050559

§ 371 Date: Nov. 26, 2025

(30) Foreign Application Priority Data
May 30, 2023 (AU) 2023901690

(51) Int. Cl. D06N 7/00; C09D 123/12

(52) U.S. Cl. CPC D06N 7/0097; C09D 123/12

(57) ABSTRACT

A printable fabric comprising: a homopolymer polypropylene yarn, yarn, the yarn comprising approximately 130 to 160 fibres per filament, the fibres comprising: a denier of approximately 600-700 D (warp and weft), a minimum break force of 30-60N, an elongation at break of greater than 10%, a coating on a front face and a rear face, wherein the coating comprises at least 60% polypropylene, at least 2% low density polyethylene, at least 2% pigment white or black, and at least 0.5% UV additive, wherein the yarn weaving pattern is plain 1×1 and with a weave density of at least 4×4 yarns per centimetre, the fabric having a nominal woven weight of at least 60 gsm.

### PRIORITY CROSS-REFERENCE

This application claims priority from Australian provisional application 2023901690 filed on 30 May 2023, the contents of which are incorporated herein by this reference.

### TECHNICAL FIELD

The invention relates to a recyclable printable fabric, whereby the entirety or most of the fabric can be fed back into the manufacturing stream. The invention further relates to the manufacture of said recyclable printable fabric.

### BACKGROUND OF INVENTION

The following discussion of background art is included to explain the context of the present invention. A reference herein to a matter which is given as prior art is not to be taken as an admission that the matter was known or that the information it contains was part of the common general knowledge as at the priority date of any of the claims.

A reference to a printable fabric or a printable banner is to a fabric or banner which can withstand standard printing processes, and upon which ink is retained. Numerous materials can be printed on however their ability to retain ink is poor, and as such those materials are not considered printable. Printable fabrics/banners are designed specifically to retain ink, and their ability to withstand the printing process and to retain ink distinguishes said printable fabrics/banners from other fabrics.

Printable banners are prevalent throughout the world and have been used to display print in the form of advertisements or for other purposes for centuries. Printable banners can be traced back to ancient civilizations such as Egypt and Greece, where messages were written or painted on large pieces of fabric and hung in public places to promote events, sales, and other messages.

In Europe during the Middle Ages, banners and flags were used to promote trade, display heraldry, and announce the arrival of important people. These banners were often hand-painted and contained intricate designs. Hand painting these banners was time consuming and expensive.

In the 19th century, the creation of the printing press along with advances in printing technology made it possible to print large images on paper, which could be used as posters and billboards.

It was not until the early 20th century that synthetic fabrics were developed, which made it possible to create durable and weather-resistant banners that could be printed with high-quality graphics. This led to the widespread use of printed banners for advertising, promotion, education and decorative purposes.

In the present, digital printing technology has revolutionized the production of banners and other advertising materials, allowing for quick and cost-effective printing of high-quality images on a variety of materials. From small banners for local events to giant billboards and stadium displays, printable banners are embedded in modern society and continue to play an important role in advertising and promotion. Most flexible printable banners in use contain some form of copolymer with a polyester woven base. Specifically, most banners at the very least comprise a fabric having a polyester woven base with a flexible PVC coating.

Printed banners that are displayed in public are often replaced for a number of reasons such as the expiry of an advertisement campaign, or due to the fadeout of the printed ink, or due to material deterioration. In such instances, the polyester-based PVC coated fabric is usually disposed of in landfill and not recycled. Recycling a polyester woven based material with a PVC coating is complex, expensive, time consuming, inefficient, and at times unreliable.

A limitation of the polyester based—PVC coated fabrics is that the fabric is not easily recyclable, and if it is recycled, it comes at a significant financial cost and generates adverse environmental emissions. The fabric manufacturing industry is aware of this issue, and to date progress has been made to create more environmentally friendly inks, as altering the entire composition of the fabrics is not commercially feasible. Certain products have now been designed to be less harmful to the environment once disposed, for example the fabric product can be incinerated without releasing harmful chemicals and thus placed in a waste-energy stream. Another innovation has been to use a water-based coating which is biodegradable. Once disposed in landfill the water-based coating does not contaminate the soil or any adjacent water streams.

It is desirable to further minimise the negative environmental effect that synthetic printable banner fabrics currently have.

### SUMMARY OF INVENTION

To further mitigate the adverse environmental effects of printable banner fabrics such as polyester woven based fabrics with PVC coating, the invention relates to a printable fabric that is mechanically recyclable with relative ease. Specifically, the invention relates to a printable polypropylene fabric. At the end of the banner life, the fabric of the invention can in its entirety be put fed into the manufacturing stream with relative ease using a predominantly mechanical shredding process, thus creating a viable closed loop solution.

According to a broad aspect of the invention there is provided a printable fabric comprising a homopolymer polypropylene yarn, the yarn comprising approximately 130 to 160 fibres per filament, the fibres comprising a denier of approximately 600-700 D (warp and weft), a minimum break force of an individual fibre 30-60N, an elongation at break of greater than 10%, a coating on a front face and a rear face, wherein the coating comprises at least 60% polypropylene, at least 2% low density polyethylene, at least 2% pigment white or black, and at least 0.5% UV additive, wherein the yarn weaving pattern is plain 1×1 with a weave density of at least 4×4 yarns per centimetre, the fabric having a nominal woven weight of at least 60 gsm.

The yarn may be any type of yarn, and in a preferred embodiment it is a multifilament yarn, and/or a tape yarn. It has been found that polypropylene multifilament yarn has numerous advantages over tape yarn. It results in a softer/more flexible and crease-resistant fabric, a smoother surface finish allowing for better print quality, an overall higher quality aesthetic, superior translucency and constancy of light transmission, and a higher strength to weight ratio.

To enhance printability of the fabric, in one embodiment the coating comprised at least 90% polypropylene.

Unlike existing printable fabrics in use, the present invention provides a printable fabric made predominantly of polypropylene which is generally entirely recyclable with relative ease. The homopolymer yarn used along with the coating is generally polypropylene. By predominantly using polypropylene, the printable fabric can simply be shredded and fed into the manufacturing process of printable fabrics as no separation of base weave and coating is required.

In comparison to the present invention, existing printable fabrics are made of composite materials such as polyester and PVC. To date, there is no known method of recycling the entire composite fabric structure as a whole, rather the individual components of the composite structure are recyclable. The individual elements require separation from the fabric, and then the separated elements can themselves be repurposed/recycled. Separating components from a composite structure requires resource intensive and expensive equipment. Further, the efficiency of the separation process varies, the process itself can be unreliable, is known to generate waste and is significantly more expensive than sourcing the individual components as raw materials. In summary, current recycling processes for existing compound fabrics such as polyester based PVC coated fabrics is expensive, inefficient, time consuming, unreliable, and not profitable.

In comparison to existing synthetic fabrics commonly used in the printable banner field, the base scrim and coating of the printable fabric of the present invention are predominantly comprised of polypropylene, thus separation is not required for recycling. Rather, the printable fabric can be merely cleaned, shredded and then fed back into the manufacturing process, thus creating a closed loop process. Alternatively, the shredded fabric can be repurposed, for example it can be used in a manufacturing process for a different compound, yarn or material.

In essence, the recycling process of the fabric of the present invention is a relatively simpler mechanical process which is faster, more scalable, more reliable and more economical to the current alternatives.

It has been found that the fabric does not necessarily need to be 100% polypropylene for the fabric to be recycled without the need for material separation. In a preferred embodiment, the fabric is made up of at least 90% polypropylene. In a further preferred embodiment, the fabric is made up of at least 90% homogenised homopolymer polypropylene yarns. In this respect additives may be included to add different material properties such as heat resistance, or increased strength or increased weathering durability.

Further, it is to be appreciated that the relatively simple mechanical recycling process is achieved by using a fabric predominantly made up of the same material. In this respect, the fabric may be made of other polymers such as polyester or polyethylene. However, it has been found that a predominately polypropylene fabric performs best in comparison to other polymers trialled.

The coating of the printable fabric in an embodiment is applied through extrusion coating. The processing temperature of the extrusion coating process may fall within the range of approximately 200 °C to 300 °C. The coating is then corona treated on both the front and rear face of the fabric, whereby the corona treatment has a minimum dyne level of 42. Ultimately, the coating on the each of the front and rear face of the fabric is somewhere in the region of 45 gsm and/or 50 um.

In one embodiment, the yarn of the printable fabric comprises between approximately 134 to 154 fibres per filament, and approximately 144 fibres per filament. The denier of the fibres is between 640 and 660 D in the warp and weft direction. In a specific embodiment, the denier of the fibres is approximately 650 D.

The fabric is designed to withstand enough force to so as not break or tear during the printing process and to be versatile with respect to the environment it can be displayed. In a preferred embodiment the minimum break force of each individual fibre is between approximately 35N and 45N, and preferably approximately 40N. The fibres can withstand the forces exerted by printing apparatus and be displayed in an internal environment or an external environment and be subjected to wind, rain and sun exposure for an extended period of time—for example a minimum of 6 months—without breaking. To this end, the fabric in its entirety can have a minimum break force of approximately at least 500N/50 mm.

Fabric resilience is desirable so as to enable the printable fabric to be displayed in a taught manner and to be able to withstand temperature variations, rain, hail, wind-force or other internal or external elements without tearing. In a preferred embodiment, each fibre comprises an elongation at break of greater than 15% and more preferably an elongation at break of greater than 20%. Similarly, the entire fabric comprises a minimum elongation at break of at least approximately 15%. It is to be appreciated elongation can be adjusted as needed, and in some circumstance an excessive elongation may make the printable fabric at times difficult to work with, while in other circumstances an excessive elongation may be desirable, particularly where printed graphics on the fabric take on a new shape or meaning in an elongated state.

To withstand typical general use throughout the life of a printable banner, in an embodiment the fabric has a minimum tear resistance of at least 80N, a minimum coating adhesion of at least 50N/50 mm, a hydrostatic pressure of at least 100 psi and a minimum burst force of at least 500N.

A polypropylene based fabric according to the present invention is versatile and allows for print to be applied in a number of manners. For example, print can be applied through UV curing or latex printing or screen printing. Alternatively, standard printing can be utilised using standard inks, or eco solvent inks.

The invention is also directed to a method of manufacturing the printable fabric according to the above forms and embodiments described in the preceding paragraphs. The method comprises the steps of spinning the polypropylene fibres into polypropylene yarn, and then weaving polypropylene yarn into fabric using flat projectile looms. The method further comprises the step of coating the front face and rear face, with a coating that is comprised of at least 60% polypropylene, at least 2% low density polyethylene, at least 2% pigment white or black, and at least 0.5% UV additive.

The invention is also directed to a method of recycling the printable fabric according to the above forms and embodiments described in the preceding paragraphs. The method comprises the steps of shredding the fabric into smaller pieces, and then feeding the shredded pieces of the fabric into an extruder to pelletise into granules. The pelletised granules can then be used in the manufacturing process of the polypropylene yarn and/or coating for use as a recyclable fabric (i.e. a closed loop use), or the granules may be repurposed into another manufacturing process requiring polypropylene granules (i.e. an external environmental use). In certain cases, the banner fabric, particularly if kept outdoors for a period of time, may contain dust, dirt, insect drops, or bird droppings. In such instances the fabric will require cleaning. In this respect, the recycling process may include the washing of the fabric. It is envisaged that de-inking of the fabric is optional, and in instances may not be required. Printed ink does not adversely impact the recycling process, rather it merely impacts the output colour of the granules, and ultimately the recycled product generated from the granules. It is not envisaged that residual ink on the granules adversely impact the recycled product, and with this in-mind, the removal of a de-inking step provides for a faster recycling process. However, if de-inking is required, it can be conducted using standard processes, such as floatation/washing or laser removal.

In a preferred embodiment the washing of the fabric involves placing the shredded fabric in a water bath and having the shredded pieces of fabric float through the bath whereby the water dissolves any dirt adhered to the fabric. In another embodiment, the cleaning process may include running the pieces of shredded fabric through a mechanical brushing process. In this respect, the cleaning process is optional, and if utilised it does not require the use of expensive or harmful cleaning agents or chemicals. Rather, if cleaning of the fabric is required, it can be executed relatively simply and quickly through the use of reliable and efficient mechanical processes.

The printable fabric of the present invention being comprised predominantly of a homopolymer polypropylene yarn with a polypropylene based coating allows the fabric to be recycled using a simple, efficient and scalable mechanical based process. With the fabric and the coating being made predominantly of the same material—polypropylene—separation is not required for recycling. The material as a whole can be fed into a simple, mechanical based, scalable recycling process. The predominantly polypropylene fabric is versatile and can be used in both external and indoor environments. It can be printed on through conventional and non-conventional methods, with print adhering to the fabric for the useful life of the fabric. In essence the printable fabric may be used as a direct substitute for existing composite fabrics whilst providing a significant cost advantage in terms of recyclability. Ultimately the fabric of the present invention provides an environmental benefit compared to existing fabrics by drastically simplifying the recycling process, thus eliminating the need to rely on resource intensive polymer separation process, removing the need for chemical-based cleaning and thus reducing the emission of harmful and toxic waste.

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereto.

### BRIEF DESCRIPTION OF THE DRAWINGS

It will be convenient to hereinafter describe a preferred embodiment of the invention and its benefits with reference to the accompanying drawing. The particularity of the drawing is to be understood as not limiting the preceding broad description of the invention.

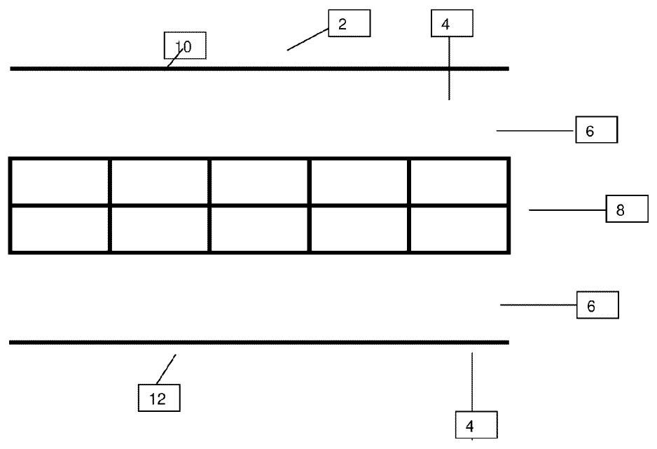

In FIG. 1 there is provided a cross-section of an embodiment of the fabric of the present invention.

### DETAILED DESCRIPTION

It will be convenient to hereinafter describe preferred embodiments of the invention and its benefits. The description of specific embodiments is to be understood as not limiting the preceding broad description of the invention.

The majority of compound based printable fabrics comprise a polyester base with a PVC coating. This compound has been universally found to provide an optimum base for a fabric for use in the advertisement industry due the advantageous printability of the fabric, its versatility and durability. However, as established in the earlier paragraphs, disposal of such fabrics results in adverse environmental effects as recycling is not economical and rarely if ever considered feasible. Existing methods to recycle these compound type fabrics are resource intensive, time consuming, expensive, unreliable and inefficient, as separation of the compounds is required. Further, the net effect of recycling such fabrics is negative to the environment as the resources required to separate compounds are themselves quite harmful and outweigh any benefit from recycling. In light of this, many fabrics end up in landfill. As a result, effort has gone into minimising the negative effect of having the fabrics in landfill, for example by utilising environmentally friendly inks, which are not toxic to soils.

The present invention provides a printable fabric capable of being recycled in a simple, cost effective, and efficient manner. The present invention provides an entirely new fabric material make up that can be recycled with relative ease. In FIG. 1, there is shown an embodiment of the fabric 2. The fabric 2 has a homopolymer polypropylene multifilament yarn woven together to form a base 8. The majority of multifilament yarns, at least 90%, of the fabric 2 are comprised of a polypropylene homopolymer. The yarn is ideally homogenised but may be of different sizes.

In alternative embodiments not shown in the drawings, other types of yarns may be combined with the homopolymer polypropylene multifilament yarns, however it is envisaged that the vast majority of multifilament yarns used are homopolymer polypropylene multifilament yarns or even homopolymer polypropylene tape yarns. The yarn may be homogenised or may be of different sizes.

Although tape yarns or other yarn forms may be used, it is preferred that multifilament yarn be used. The use of multifilament polypropylene yarns has been found to be advantageous over tape polypropylene yarns.

The use of multifilament yarns has been found to result in softer/more flexible fabrics being more resistant to creasing. This assists with folding and transportation. Further, the use of polypropylene multifilament yarns results in a smoother surface finish, which is a desirable benefit for printing, as it allows for enhanced print quality. It has been found that the use of multifilament polypropylene yarns in the fabric 2 makeup creates a higher overall fabric aesthetic, which is particularly important for where the fabric 2 and print is to be used for close-up viewing. Compared to polypropylene tape yarns, multifilament yarns have a higher strength to weight ratio and provide superior translucency and constancy of light transmission which is critical for back lit applications.

By using predominantly homopolymer polypropylene yarns, and a polypropylene based coating 6, the printable fabric 2 can simply be shredded, granulated, and ultimately fed into the manufacturing process of the fabric 2, thus providing a closed loop process. No time consuming and resource intensive separation of materials is required to recycle the fabric of the present invention as the fabric is predominantly made of the same material, polypropylene.

In a specific embodiment, the yarn weaving pattern used to form the fabric base is a plain 1×1 pattern. The weave density of the 1×1 weave pattern can be as low as 4×4 yarns per centimetre, and in a specific embodiment is 6×6 yarns/cm+/−10%. The nominal woven weight of the fabric is at least 60 gsm, and where the weave density is 6×6 yarns/cm+/−10%, the weight of the fabric is at least 90 gsm+/−10%.

Alternative weave patterns may be used to provide the fabric with different textures, or strength properties. Similarly, the weave density can be increased or decreased to provide the fabric with different properties fit for purpose. For example, a higher weave density will result in a stiffer fabric as opposed to a lower density. Ultimately, altering these properties will result in a higher or lower nominal woven weight.

The polypropylene multifilament yarns used to form the fabric base 8 can have anywhere between approximately 130 to approximately 160+/−10% fibres per filament. In a specific embodiment, the polypropylene multifilament yarn is comprised of approximately 144 fibres per filament+/−10%.

The individual fibres of the polypropylene multifilament yarn can have a denier of approximately 600-700 D (warp and weft)+/−10%. Alternatively, the yarn can have a denier of approximately 640-600 D+/−10%. In a specific embodiment the denier is approximately 650 D+/−10%. The minimum break force of each fibre is approximately between 30 to 60 N, with an elongation of greater than at least 10%, or even 15%. In a specific embodiment, the individual fibres have a break force greater than at least 40 N with an elongation greater than at least 20%.

According to above noted parameters of the individual fibres and the weave pattern, the fabric 2 of FIG. 1 has a minimum tensile force of at least approximately 500N/50 mm, a minimum elongation at break of at least approximately 15%, and a minimum tear resistance of at least approximately 80N. The fabric 2 is also designed to have a hydrostatic pressure of at least approximately 100 psi and a minimum burst force of at least approximately 500N.

To enable print to adhere to the fabric 2, a coating 6 is applied on a front face 10 and a rear face 12 of the fabric 2. In the scenario that only one side of the fabric is to be printed on, it is possible to apply the coating to one of the front 10 or rear 12 faces. The coating 6 is applied to the fabric through extrusion coating with a processing temperature of approximately 200 °C to approximately 300 °C, and more specifically, approximately 240 °C to approximately 270 °C. Alternatively, the coating can be applied through different methods, for example, lamination.

The coating 6 is generally comprised of at least 60% polypropylene, at least 2% low density polyethylene, at least 2% pigment white or black, and at least 0.5% UV additive. In a specific embodiment, the coating 6 comprises approximately 90% polypropylene, approximately 5% low density polyethylene, 4% pigment white or black, and 1% UV additive.

The fabric 2 of FIG. 1 has a minimum coating adhesion of at least 50N/50 mm. Therefore, once the coating is applied to the fabric, it can be printed on. Print can be applied through conventional and contemporary printing techniques such as UV curing, latex printing, standard printing comprising eco solvent inks, or screen printing. Therefore, in a specific embodiment, the fabric 2 has print applied through UV curing and/or latex printing, and/or standard printing comprising eco solvent inks, and/or screen printing and/or any other feasible print method.

To enhance print/ink adhesion, the coating applied to the fabric is corona treated 4 at a minimum approximate dyne level treatment of 42 at approximately 45 gsm and/or 50 um. In this respect, if only the front face 10 of the fabric is coated, then the front face 10 coating will subsequently be corona treated at for example a dyne level of 42 with a weight of approximately 45 gm and/or a thickness of 50 um.

The predominantly polypropylene fabric 2 is versatile and can be used in external and indoor environments. It can be printed on through conventional and non-conventional methods. With this in mind the printable fabric 2 can be used to replace existing composite fabrics, and in doing so can provide a significant cost and environmental advantages in terms of recyclability. The printable fabric 2 of the present invention being comprised of a homopolymer polypropylene multifilament yarn allows it to be recycled using a simple and scalable mechanical based process.

Unlike existing printable fabrics in use, the present invention provides a printable fabric made entirely of a homopolymer polypropylene based fibre and having a polypropylene based coating, making it entirely recyclable with relative ease. In this respect, no separation of polymer elements of the fabric is required for recycling. As noted earlier, separation of synthetic fabrics such as those that are polyester based with PVC coating is resource intensive, inefficient, expensive, time consuming, unreliable and generates waste. The adverse effects of recycling fabrics such those that are polyester based with PVC coating have been known to outweigh any benefit generated from recycling.

By only using homopolymer polypropylene multifilament yarn, the printable fabric 2 of the present invention can simply be shredded, and then granulated, and ultimately fed into the manufacturing process of printable fabrics, thus providing a closed loop process. The granulated fabric can also be repurposed or fed into the manufacturing process of different yarns or fabrics.

The invention is also directed to a method of manufacturing the printable fabric 2 described in the preceding paragraphs. The method comprises the steps of spinning the polypropylene fibres into polypropylene yarn, and then weaving polypropylene yarn into fabric using flat projectile looms. The method further comprises the step of coating the front face and rear face with a polypropylene based coating 4. In this respect, the coating applied comprises 60% polypropylene, at least 2% low density polyethylene, at least 2% pigment white or black, and at least 0.5% UV additive. Specifically, the coating 6 is comprised of approximately 90% polypropylene, approximately 5% low density polyethylene, 4% pigment white or black, and 1% UV additive.

The invention is also directed to a method of recycling the printable fabric 2 as described in the preceding paragraphs. The method comprises the steps of shredding the fabric 2 into smaller pieces. The shredded pieces are then feed into an extruder, which pelletises the shredded pieces into granules. The pelletised granules can then be used in the manufacturing process of the polypropylene yarn and/or coating.

In some cases, it is expected that the banner fabric, particular if kept outdoors for a period of time, may collect dust, dirt, insect drops, or bird droppings. In such instances where the fabric has been exposed to contaminants or contains dirt it will need to be cleaned. In such circumstances cleaning will be part of the recycling process, otherwise, cleaning may be an optional step.

The fabric can be cleaned relatively simply and quickly, without the use of harmful chemicals or solvents. For example, the fabric may be washed, which involves floating the shredded pieces of fabric through a water bath. The water either displaces or dissolves any dirt adhered to the fabric. Alternatively, or in addition to washing, the shredded fabric is cleaned by subjecting the shredded fabric to a mechanical brushing process. The mechanical brushes simply and quickly remove/displace any dirt attached to the shredded fabrics.

The cleaning process of the fabric 2 does not require the use of expensive or harmful cleaning agents or chemicals. Rather, if in the event cleaning of the fabric is required in the recycling process, it can be executed quickly in a relatively simple, cost effective, and efficient manner having little to no adverse environmental impact.

De-inking of the fabric 2 is optional as it is not essential for recycling. Printed ink does not adversely impact the recycling process, rather it merely impacts the colour of the shredded granules, and ultimately the colour of the recycled product generated from the granules. It is not envisaged that residual ink on the granules adversely impact the recycled product, and with this in-mind, the removal of a de-inking step provides for a faster recycling process. However, if de-inking is to be performed, it can be conducted using standard processes, such as floatation/washing or laser removal. The de-inking process used, will ultimately depend on the type and amount of ink used.

Ultimately the fabric of the present invention provides a significant potential environmental benefit compared to existing fabrics by drastically simplifying the recycling process to a reliable and efficient mechanical system. The process removes the need for separation of polymers thus eliminating the use of harmful chemicals, resource intensive processes and ultimately reducing waste. In this respect the vast majority of the fabric 2 can be recycled at a very high efficiency, and then re-fed into the manufacturing process, thus reducing harmful and toxic waste ending up in landfill.

It is to be understood that various alterations, modifications and/or additions may be introduced into the construction and arrangement of the parts previously described without departing from the spirit or ambit of this invention.

1. A printable fabric comprising:
a homopolymer polypropylene yarn,
the yarn comprising approximately 130 to 160 fibers per filament,
the fibers comprising:
a denier of approximately 600-700 D (warp and weft),
a minimum break force of 30-60N,
an elongation at break of greater than 10%,
a coating on a front face and a rear face, wherein the coating comprises at least 60% polypropylene, at least 2% low density polyethylene, at least 2% pigment white or black, and at least 0.5% UV additive,
wherein the yarn weaving pattern is plain 1×1 and with a weave density of at least 4×4 yarns per centimetre, the fabric having a nominal woven weight of at least 60 gsm.

2. The printable fabric according to claim 1, wherein the homopolymer polypropylene yarn is a multifilament yarn or a tape yarn.

3. The printable fabric according to claim 1, wherein at least 90% of yarns are polypropylene homopolymer yarns.

4. The printable fabric according to claim 1, wherein the coating comprises at least 90% polypropylene.

5. The printable fabric according to claim 4, wherein the coating is applied through extrusion coating having a processing temperature of approximately 200 °C to 300 °C.

6. The printable fabric according to claim 5, wherein the coating is corona treated on the front and rear face.

7. The printable fabric according to claim 6, wherein the corona treatment has a minimum dyne level of 42.

8. The printable fabric according to claim 4, wherein the coating is 45 gsm or 50 um on each of the front and rear face.

9. The printable fabric of claim 1, wherein the yarn comprises 134 to 154 fibers per filament.

10. The printable fabric according to claim 9 wherein the yarn comprises approximately 144 fibers per filament.

11. The printable fabric according to claim 1, wherein the denier of the fibers is between 640 and 660 D (warp and weft).

12. (canceled)

13. The printable fabric according to claim 1, wherein the minimum break force of each fiber is between 35 and 45N.

14. The printable fabric according to claim 13, wherein the minimum break force of each fiber is 40N.

15. The printable fabric according to claim 1, wherein each fiber comprises an elongation at break of greater than 15%.

16. The printable fabric according to claim 15, wherein each fiber comprises an elongation at break of greater than 20%.

17. The printable fabric according to claim 1, wherein the fabric comprises a minimum tensile force of at least approximately 500N/50 mm, a minimum elongation at break of at least approximately 15%, and a minimum tear resistance of at least 80N, a minimum coating adhesion of at least 50N/50 mm, a hydrostatic pressure of at least 100 psi and a minimum burst force of at least 500N.

18. The printable fabric according to claim 1, comprising print applied through UV curing or latex printing, or standard printing comprising eco solvent inks, or screen printing.

19. A method of manufacturing the printable fabric according to claim 1 comprising:
spinning the polypropylene fibers into polypropylene yarn,
weaving polypropylene yarn into fabric using flat projectile looms,
applying a coat on the front face and rear face of the fabric, the coating comprising at least 60% polypropylene, at least 2% low density polyethylene, at least 2% pigment white or black, and at least 0.5% UV additive.

20. A method of recycling the printable fabric according to claim 1 comprising:
shredding the fabric into smaller pieces,
feeding the shredded pieces of the fabric into an extruder to pelletise into granules.

21. The method of claim 20 comprising washing the fabric before shredding the fabric.
